(19) United States
(12) Patent Application Publication
(10) Pub. No.: US 2024/0336871 A1
(43) Pub. Date: Oct. 10, 2024

(54) DECORATIVE LOVE COUPLE CANDLE

(71) Applicant: Sung Bok JIN, Seoul (KR)

(72) Inventor: Sung Bok JIN, Seoul (KR)

(21) Appl. No.: 18/290,687

(22) PCT Filed: Apr. 18, 2023
(86) PCT No.: PCT/KR2023/005221

§ 371 Date: Jan. 19, 2024

(30) Foreign Application Priority Data
May 12, 2022 (KR) 10-2022-0058294

(51) Int. Cl. C11C 5/00

(52) U.S. Cl. CPC C11C 5/008

(57) ABSTRACT

The present invention relates to a decorative love couple candle for directly or indirectly indicating, through the exterior shape of a candle or the flow of wax drippings generated during combustion, that a man and a woman have fallen in love and become husband and wife, the candle comprising: a body part including a first body and a second body; a dividing part which is formed along one longitudinal side of the body part, and which divides the body part into each of the first body and the second body; and a first wick formed at the upper portion of the first body and a second wick formed at the upper portion of the second body.

### TECHNICAL FIELD

The present invention relates to a decorative love couple candle, and more particularly, to a decorative love couple candle which directly or indirectly shows that a love between a man and a woman has come to bear a fruit and form a couple by the flow of candlelight generated during a candle appearance or combustion phenomenon.

### BACKGROUND TECHNOLOGY

Traditionally, candles have only served as light sources for illuminating the surroundings, but in modern society where light sources using electricity are developed, candles are used not only as light sources but also for various purposes, such as deodorants for catching odors, fragrances emitting subtle scents, interior props, event gifts, etc.

Registered Utility Model No. 20-0290633 “Ornament Using Candle With Two Wicks” discloses a candle that expresses both sides' reliance on each other without being lonely by producing two flames, and Published Utility Model No. 2020210001412 “Candle Assembly Having Multi-Wick” discloses a candle consisting of two or more wooden wicks in which the wicks of wick members are spaced apart, and these conventional techniques have disadvantages in that a love between a man and a woman cannot show or symbolize a process of becoming a couple by fruiting a love between a man and a woman through the appearance of a candle or through a process in which a candle generated by burning a candle flows.

### DETAILED DESCRIPTION OF THE INVENTION

### Technical Problems

In order to solve the problem mentioned above, the present invention provides a candle, which is two and forms one body, more specifically expresses a love between a man and a woman, which could not be seen in existing candles.

More specifically, a couple is a one-heart body that is both a man and a woman and one at the same time. Accordingly, the decorative love couple candle of the present invention is formed in consideration of such a point, and thus two bodies look like one by the partitioning unit, but is consequently combined into one. It also emphasizes more specifically the meaning of the combination of men and women through the process of candlelight vigils.

### Technical Solving Method

In order to achieve the above object, disclosed is a decorative love couple candle, comprising: a body unit including a first body and a second body; a partitioning unit formed along one side in the longitudinal direction of the body unit, and partitioning the body unit into a first body unit and a second body unit, respectively; a first wick formed on the upper part of the first body; and a second wick formed on the upper part of the second body.

The first body may have an upper part protruding convexly at a predetermined height, an upper part of the second body may have a shape concavely recessed at a predetermined height, the first wick may be formed on the protruding shape, the second wick may be formed in the recessed shape, and the first concave groove may be formed in a circular shape along an edge of the protruding shape, a second concave groove may be formed in a circular shape along an edge of the recessed shape, and a passage connecting the first concave groove and the second concave groove.

The length of the first wick may be different from the length of the second wick.

### Effects of the Invention

Through the present invention, it can be expressed through the appearance and combustion phenomenon of the candle that the love between a man and a woman has formed a fruit and forms a couple. The present invention can economically save the cost of purchasing candles rather than purchasing two candles individually by using the one candle instead of using each candle separately, and can be expected to improve the gold thread between the couples, which is an economic community, through the present invention which symbolizes the love of a couple.

### BRIEF DESCRIPTION OF DRAWINGS

FIG. 1 to FIG. 4 are views showing a decorative love couple candle according to the present invention.

FIG. 1 is a perspective view showing an embodiment of the decorative love couple candle according to the present invention.

FIG. 2 is a plan view and a front view showing an embodiment of the decorative love couple candle according to the present invention.

FIG. 3 is a plan view and a front view showing an embodiment of the decorative love couple candle according to the present invention.

and FIG. 4 is a plan view and a front view showing an embodiment of the decorative love couple candle according to the present invention.

### BEST MODE OF THE PRESENT INVENTION

Hereinafter, some embodiments of the present invention will be described in detail with reference to exemplary drawings. In adding reference numerals to elements in each drawing, it should be noted that the same elements will be designated by the same reference numerals, if possible, although they are shown in different drawings. Further, in describing the present exemplary embodiment, when it is determined that a detailed description of related known features or functions may obscure the gist of the present exemplary embodiment, the detailed description thereof will be omitted.

In describing components of the present embodiment, reference numerals such as first, second, a), b) and the like may be used. Such a code is used only to distinguish the constituent element from other constituent elements, and the nature, sequence, or sequence of the corresponding constituent element is not limited by the code. In addition, when a part of the specification “includes” or “includes” a component, this means that other components may be further included, rather than excluding other components, unless explicitly stated otherwise. In addition, in the specification, when “connecting,” “installing,” or “attaching,” it does not mean only direct connection, direct installation, or attachment between components, but it should be interpreted as including indirect connection, installation, or attachment through other components in the broadest sense.

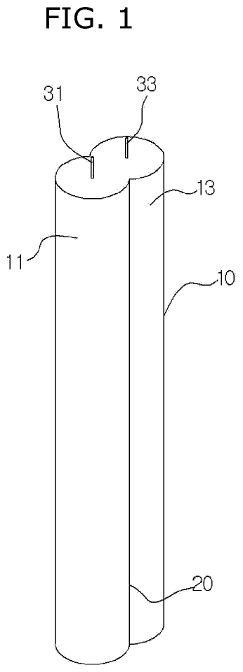

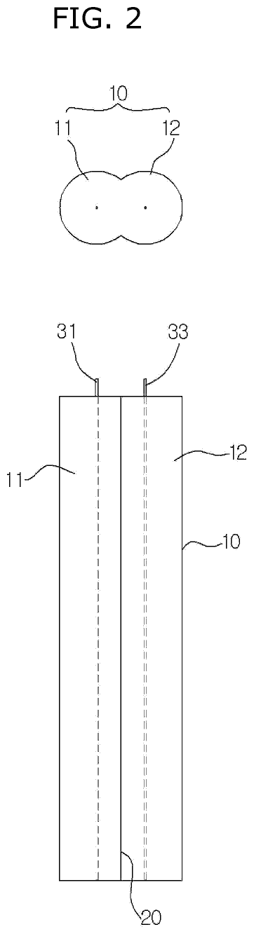

FIGS. 1 to 4 show a decorative love couple candle according to the present invention.

Referring to FIGS. 1 to 4, a decorative love couple candle according to the present invention may include a body unit 10 including a first body 11 and a second body 13, a partition unit 20 formed along one side in a length direction of the body unit 10 and partitioning the body unit 10 into the first body 11 and the second body 13, a first wick 31 formed on the first body 11, and a second wick 33 formed on the second body 13.

Further, the first body 11 may have an upper part protruding convexly at a predetermined height, the second body 13 may have an upper part recessed concavely at a predetermined height, the first wick 31 may be formed on the protruding shape, the second wick 33 may be formed within the recessed shape, and the electronic device may include a first concave groove 41 formed in a circular shape along an edge of the protruding shape, a second concave groove 43 formed in a circular shape along an edge of the recessed shape, and a passage connecting the first concave groove 41 and the second concave groove 43.

In addition, the length of the first wick 31 may be different from the length of the second wick 33.

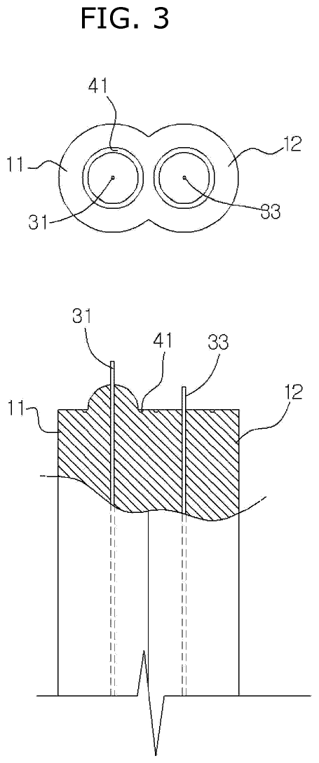

Referring to FIGS. 1 and 2, the body unit 10 may include a first body 11 and a second body 13, wherein the first body 11 represents a male, and the second body 13 represents a female.

The partition unit (20) is a boundary for dividing the body unit (10) into the first body (11) and the second body (13), thereby enabling appeared as if two candles or one candle that two candles coupled each other according to the way looking at the decorative love couple candle.

The decorative love couple candle of the present invention specifically expresses the process of an important matter of life, in which a man and a woman, who were originally males, meet each other to make love and couple together, through the shape of a candle and the process of burning the candle.

The first wick 31 and the second wick 33 are formed on the first body 11 and the second body 13, respectively, and the first wick 31 and the second wick 33 may be formed of the same length, thickness, or material, or may be formed of different lengths, thicknesses, or materials.

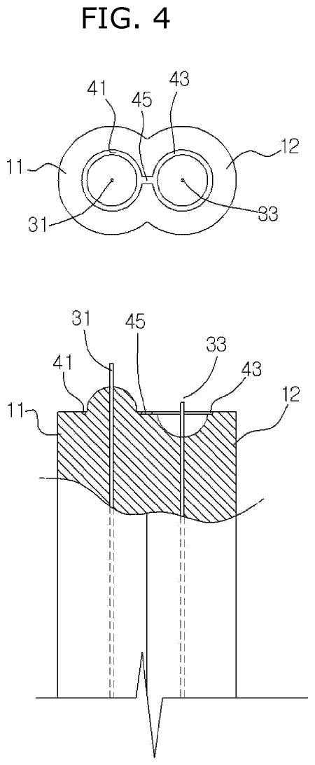

Referring to FIGS. 3 and 4, the first body 11 may have a shape in which an upper part thereof convexly protrudes at a predetermined height. The convexly protruding shape symbolizes a man who is a yang in the Yin-yang and five elements.

The second body 13 may have a shape in which an upper part is concavely recessed at a predetermined height. The concave recessed shape above symbolizes a woman who is yin in the Yin-yang and five elements.

The body unit 10 is divided into a first body 11 and a second body 13 and is coupled to each other. The appearance of Love Candle directly or indirectly symbolizes the relationship between the couple, that is, the couple is both but one at the same time, as the men and women who were separated met each other, loved each other, and formed a relationship between the couple.

The convexly protruded shape of the first body 11 may have various curves and curvatures, and various shapes such as a height (depth), a thickness, a width, and the like of the shape may be used. The convexly protruding shape may be, for example, a size and a shape of ‘ [symbol] ’, and the shape shown in the drawing is only an exemplary substrate among various shapes that the present invention may have, and the present invention is not limited thereto. Similarly, the concavely recessed shape of the second body 13 may be, for example, a shape such as ‘ [symbol] ’, may have various curves and curvatures, and may have various shapes in terms of height (depth) and width. Thus, when the protruding shape and the concave shape have an appropriate thickness, height, thickness, and the like, they can be aesthetically excellent, and economically and efficiently manufactured and produced. If the thickness of the convexly protruding shape is too thin or long, there is a risk of easily breaking and it is not good to see in aesthetics. As the first body 11 symbolizes a man, the convexly protruding shape needs to have an appropriate thickness and height to well reflect such a symbolic meaning.

The first wick 31 may be formed on the protruded shape of the first body 11, and the second wick 33 may be formed in the depressed shape of the second body 13, and in this case, the lengths of the first wick 31 and the second wick 33 may be different from each other.

The first concave groove 41 may be formed in an upper part of the first body 11, and when the upper part of the first body 11 protrudes convexly by a predetermined height, it may be formed in a circular shape along an edge of the protruding shape.

The second concave groove 43 may be formed in the upper part of the second body 13, and when the upper part of the second body 13 is concavely recessed at a predetermined height, it may be formed in a circular shape along the edge of the concaved shape.

The passage 45 may be installed such that the first concave groove 41 and the second concave groove 43 are connected to each other, and the candlelight, which has flowed in the first concave groove 41 due to the combustion of the first body 11, flows into the passage 45 connected to the first concave groove 41, and eventually flows into the second concave groove 43 connected to the passage 45. As described above, in the present invention, as the body unit 10 of the love candle burns, the flow of the candle occurs from the convexly protruded shape of the first body 11, which symbolizes a male, who is Yang, to the concavely depressed shape of the second body 13, which symbolizes a female, who is Yin, at Yin-yang and five elements, and it represents important meaning that male and female meet and accept each other as husband and wife, and harmonious yin-yang unity has built reasonably.

Hereinafter, the operation and effect of the decorative love couple candle according to the present invention will be described as follows. The following description follows the structure description.

Referring to FIG. 3, the upper part of the first body 11 may be convexly protruded at a predetermined height, and when the first wick 31 is ignited and combustion occurs, the candlelight melted from the first body 11 flows into the first concave groove 41. The candlelight flowing in the first concave groove 41 eventually overflows into the second concave groove 43 formed in the second body 13. The first body (11) represents a man, and the second body (13) represents a woman, and the meaning that the energy of a man has flowed into a woman is transmitted through the flow of candles.

Referring to FIG. 4, the second body 13 may have a shape in which it is concavely recessed at a predetermined height, and the candlelight generated by the melting of the first body 11 first flows into the first concave groove 41, and eventually flows into the second concave groove 43 through the passage 45 connecting the first concave groove 41 and the second concave groove 43. The candlestick flowing into the second concave groove 43 eventually flows into the concave shape of the second body 13 at a predetermined height.

According to the present invention, the first body (11) and the second body (13) represent men and women, respectively, and the candlelight generated from the first body (11) represents the energy or energy of the men. This indicates that the candlelight flows into the second concave groove (43) of the second body (13) or the concave depression of the second body (13) which represents women, thus joining men and women, that is, the love between men and women bear fruit to form a relationship or achieve a yin-yang unity. The present invention is suitable for giving a present to a man and a woman who have formed a relationship or a newly married couple with a desire to cherish, love, and have a happy family in the future.

In the above, a preferred embodiment of the present disclosure has been illustrated and described, but the present disclosure is not limited to the above-described specific embodiments, and various modifications may be made by those skilled in the art without departing from the spirit of the present disclosure claimed in the claims, and such modifications should not be individually understood from the technical spirit or the prospect of the present disclosure.

1. A decorative love couple candle comprising: a body unit including a first body and a second body; a partitioning unit formed along one side in a length direction of the body unit and partitioning the body unit into a first body unit and a second body unit; a first wick formed on an upper part of the first body; and a second wick formed on an upper part of the second body.

2. The decorative love couple candle of claim 1, wherein an upper part of the first body is convexly protruded at a predetermined height, an upper part of the second body is concavely depressed at a predetermined height, the first wick is formed on the protruded shape, and the second wick is formed in the depressed shape.

3. The decorative love couple candle of claim 1, further comprising: a first concave groove formed in a circular shape on an upper part of the first body; and a second concave groove formed in a circular shape on an upper part of the second body.

4. The decorative love couple candle of claim 3, further comprising a passage connecting the first concave groove and the second concave groove.

5. The decorative love couple candle of claim 1, wherein an upper part of the first body has a shape protruding convexly by a predetermined height, and the decorative love couple candle further comprises a first concave groove formed in a circular shape along an edge of the protruding shape.

6. The decorative love couple candle of claim 1, wherein an upper part of the second body is concavely recessed at a predetermined height, and the decorative love couple candle further comprises a second concave groove formed in a circular shape along an edge of the concaved shape.

7. The decorative love couple candle of claim 1, wherein an upper part of the first body is convexly protruded at a predetermined height, and further comprises: a first concave groove formed in a circular shape along an edge of the protruded shape; and a second concave groove formed in a circular shape at an upper part of the second body.

8. The decorative love couple candle of claim 1, wherein an upper part of the first body has a shape protruding convexly at a predetermined height, an upper part of the second body has a shape recessed concavely at a predetermined height, the first wick is formed on the protruding shape, and the second wick is formed within the recessed shape and is formed in a circular shape along an edge of the protruding shape;
wherein a second concave groove formed in a circular shape along an edge of the recessed shape; and a passage connecting the first concave groove and the second concave groove.

9. The decorative love couple candle of claim 1, wherein the first wick and the second wick have different lengths.
